(19) United States
(12) Patent Application Publication
(10) Pub. No.: US 2026/0003656 A1
(43) Pub. Date: Jan. 1, 2026

(54) INTELLIGENT INTRA-SYSTEM AUTHENTICATION PROTOCOLS

(71) Applicant: Bank of America Corporation, Charlotte, NC (US)

(72) Inventors: Maneesh Kumar Sethia, Hyderabad Telangana (IN); Abhijit Behera, Hyderabad Telangana (IN); Saurabh Garg, Faridabad Haryana (IN)

(21) Appl. No.: 18/755,837

(22) Filed: Jun. 27, 2024

(51) Int. Cl. G06F 9/455; H04L 69/22

(52) U.S. Cl. CPC G06F 9/45558; H04L 69/22; G06F 2009/45587

(57) ABSTRACT

Systems, methods, and apparatus are provided for intelligent intra-system data authentication. An AI engine, using generative AI algorithms, may screen network data and obtain telemetry and TCP data associated with a data packet. The AI engine may output a set of data path parameters associated with the data packet. The AI engine may adapt the data path parameters based on smart contract rules and other factors. The data packet may be processed using one or more intra-system applications. The AI engine may authenticate the data packet against the data path parameters in a multi-stage intra-system authentication. When one stage of authentication fails, the AI engine may restrict the data packet, preventing transmission past a point of restriction.

### FIELD OF TECHNOLOGY

Aspects of the disclosure relate to using artificial intelligence (AI) to dynamically implement data security protocols.

### BACKGROUND OF THE DISCLOSURE

Data packets are routinely transferred from one system to another. While data entering an enterprise system from upstream applications may be checked for malware or other threats, data exiting the system to downstream applications is typically not verified.

It would be desirable to apply generative AI algorithms and smart contract logic to internally authenticate intra-system data prior to exit from the system. It would be further desirable to dynamically adapt these authentication protocols to real-time system load demands in order to balance the additional burden of intra-system verification with system efficiency and productivity.

### SUMMARY OF THE DISCLOSURE

Systems, methods, and apparatus are provided for intelligent intra-system authentication protocols.

A system may receive a data packet from an intersystem network. The system may include an artificial intelligence (AI) engine that uses one or more generative artificial intelligence algorithms. The AI engine may screen the network data and obtain telemetry data and transfer control protocol (TCP) data associated with the data packet. The AI engine may output a set of data path parameters associated with the data packet.

The AI engine may validate an instance of a Java Virtual Machine (JVM) against the data path parameters. The AI engine may validate downstream application schema against the data path parameters. The AI engine may adapt the data path parameters based on smart contract rules. In some embodiments, the AI engine may dynamically adapt the data path parameters and/or the smart contract rules based on a real-time snapshot of system resources.

The data packet may be processed at the JVM instance by one or more intra-system applications. The AI engine may authenticate the data packet against the data path parameters in a multi-stage intra-system authentication. A first authentication may be implemented at initiation of the JVM instance. A second authentication may be implemented at completion of processing at the JVM instance. A third authentication may be implemented at a point of exit from the system.

Any suitable number of authentications may be implemented at any suitable number of points within the system. The number and timing of authentications may be varied based on the smart contract rules. The number and timing of the authentications may be varied by the AI engine. The number and timing of the authentications may be varied by predetermined system settings or by a system administrator.

When the first, second, or third authentication fails to validate the data packet against the data path parameters, the AI engine may issue an alert. The AI engine may notify upstream and downstream applications. The AI engine may restrict the data packet, preventing transmission past a point of restriction.

### BRIEF DESCRIPTION OF THE DRAWINGS

The objects and advantages of the disclosure will be apparent upon consideration of the following detailed description, taken in conjunction with the accompanying drawings, in which like reference characters refer to like parts throughout, and in which:

FIG. 1 shows illustrative apparatus in accordance with principles of the disclosure;

FIG. 2 shows illustrative apparatus in accordance with principles of the disclosure;

FIG. 3 shows an illustrative process flow in accordance with principles of the disclosure; and

FIG. 4 shows an illustrative process flow in accordance with principles of the disclosure.

### DETAILED DESCRIPTION

Systems, methods, and apparatus are provided for intelligent intra-system authentication protocols.

For the sake of illustration, the invention will be described as being performed by a “system.” The system may include one or more features of apparatus and methods that are described herein and/or any other suitable device or approach.

Data authentication may include protocols for verifying the origin and/or integrity of intra-system data.

The system may include an artificial intelligence (AI) engine. The AI engine may include one or more generative AI algorithms. Any suitable artificial intelligence or machine learning algorithms may be applied.

The AI engine may be a wrapper engine that sits outside existing system architecture. The AI engine may be a plugin that adapts existing system architecture.

The system may receive a data packet. The data packet may be an intersystem data packet. The data packet may be received from a different enterprise system. The data packet may be received from outside enterprise systems. The AI engine may obtain telemetry data and transmission control protocol (TCP) data associated with the data packet from the intersystem network.

Network telemetry data may refer to the automatic collection and transmission of data from remote sources for monitoring and analysis. Telemetry data may provide information about application performance, latency, throughput, resource utilization and/or any suitable information. Telemetry data may be sourced from application logs, system logs, network traffic, third party services, APIs, or any suitable source. Network telemetry data may include logs, metrics, events and traces.

Network telemetry data may include metrics. Metrics may be values measured over time. Metrics may include numerical measurements such as error rate or percentage CPU use.

Network telemetry data may include events. Events may be discrete occurrences associated with an application request. Examples of events may include user login attempts, alert notifications, HTTP requests or responses, or any suitable event.

Network telemetry data may include logs. Logs may be text-based records of events and may provide a descriptive record of system behavior.

Network telemetry may include traces. A trace may refer to the path of a request or workflow as it moves through the system. The trace may provide a collection of operations that represent a unique transaction handled by an application. Examples of traces may include an SQL query execution or a function call that occurs during a user authentication request.

The network telemetry data may include directory information such as a data source path and a data destination path. The network telemetry data may include a Java Virtual Machine (JVM) instance name. The network telemetry data may include a data center associated with application data. The network telemetry data may include any suitable telemetry data.

Telemetry data may be obtained through any suitable network monitoring and analysis tools associated with the network. Telemetry may be extracted from the data plane, control plane, management plane or any suitable network infrastructure. Telemetry data may be obtained using continuous packet capture tools.

Network telemetry may involve protocols such as Simple Network Management Protocol (SNMP) or NetFlow that enable data collection from network devices and routers. In some embodiments, network devices may periodically push device information to a collector. Network data may be obtained from an observability framework such as OpenTelmetry.

The AI engine may also obtain Transmission Control Protocol (TCP) data associated with the data packet from the intersystem network. TCP is a transport protocol that is used on top of IP to ensure reliable transmission of packets.

TCP data may include sequence number, bandwidth control, port number, data destination path, and/or any suitable TCP data. Sequence number may indicate the place of the request in a queue. Bandwidth control parameters may enable users to define ingress and egress rate limits for a specific port. The port number may specify a port associated with the bandwidth settings.

The AI engine may screen all incoming network data associated with a data packet. The AI engine may generate a set of data path parameters associated with the data packet. The data path parameters may be based on the network telemetry and TCP data. The data path parameters may be a set of reference data path parameters. The data path parameters may be dynamically customized to the data packet based on real-time information received from the network at the time of entry into the system.

The AI engine may access a smart contract. Smart contract code may facilitate, verify and enforce the performance of an agreement or transaction. A smart contract may include a set of rules under which parties agree to interact with each other. The smart contract may operate on an if-then principle. If the pre-defined rules are met, the agreement may be automatically enforced.

The smart contract may be codified on a distributed electronic ledger. A distributed electronic ledger may store records in any suitable format. For example, records may be stored sequentially as they are generated. Records may be stored in blocks, such as in a blockchain.

The distributed ledger may link details of the smart contract from an external repository. The distributed ledger may link different parties that participate in the smart contract.

Parties to the smart contract may be associated with the origin point of the data packet. Parties to the smart contract may be associated with downstream applications that will receive the data packet. Parties to the smart contract may include networks or any suitable party that will interact with the data packet. In some embodiments, the smart contract logic may be associated with an enterprise system and may define intra-system parameters. In some embodiments, the data packet header may include an identifier for the smart contract.

Smart contract logic may define data path parameters that are acceptable for the system. Smart contract logic may define the data parameters that are used to authenticate a data packet within the system. Smart contract rule sets may define which input data should be verified against which output data.

The AI engine may determine the set of set of reference data path parameters based on the smart contract logic. The AI engine may verify that the data path parameters correspond to the network telemetry and TCP data for the data packet.

The AI engine may verify a Java virtual machine (JVM) instance with the data path parameters for the data packet. A JVM provides runtime environment that supports Java applications. The JVM may also help manage and optimize resources during program execution. A JVM implementation may refer to the software that executes Java bytecode. Different implementations may have different performance characteristics and optimizations. A JVM instance may be created when a Java class file is run.

The AI engine may verify that the data path parameters conform to all aspects of the JVM instance. The AI engine may verify that the JVM instance will not introduce any additional data path parameters. The AI engine may modify the set of reference data path parameters based on predicted changes to the parameters associated with the JVM instance.

The AI engine may receive schema and requirements associated with downstream applications. The AI engine may verify that the data path parameters conform to downstream requirements. The AI engine may modify the set of reference data path parameters based on predicted changes to the parameters associated with the downstream application schema.

Internal system components may include multilevel architecture. System components may include one or more databases. System components may include middleware. System components may include outward-facing applications, such as an electronic payment hub. Intra-system workflows may include database requests, batch jobs, and/or any suitable workflows.

In some embodiments, application requests associated with outward-facing intra-system workflows may be managed by a device handler. The device handler may receive requests and interface with the database layer to respond to the request.

Intra-system applications may output a processed data packet for exit to downstream applications. The AI engine may verify the parameters of the output data packet against the smart contract parameters for the data packet. The AI engine may verify the parameters of the output data packet against the path data used to verify the input data packet. The AI engine may verify the parameters of the output data packet against the set of reference data path parameters.

The smart contract rules may adaptively change over time. In some embodiments, the AI engine may adapt the smart contract rules.

Smart contract rules may adapt to changes in data path parameters in an output data packet. For example, a new intra-system application may output a data packet with a total number of parameters that does not match the total number of parameters associated with an input data packet. The AI engine may recognize that this change is associated with routine processing and does not indicate the addition of malicious code. Similarly, when verifying the JVM instance against the data path parameters, the AI engine may determine that the JVM instance introduces an additional data path parameter. The smart contract logic may adapt to permit this additional data path parameter in the output data packet. In another example, the parameter naming convention for the exit data may not match the input data. The AI may determine that this change results from application requirements and is not a result of tampering.

Smart contract rules may adapt to changes in the data path. If the path data for the output data packet does not correspond to the smart contract rules for the data packet, the AI engine may determine whether the deviation is acceptable. For example, the reference data path parameters may specify a path, but the packet may have been diverted due to internal system load requirements. The AI engine may determine that this diversion does not constitute a threat.

In some embodiments, the AI engine may use the parameters associated with the input packet to manage intra-system load. The AI engine may route the data packet on a path that is compatible with the rules established in the smart contract. The AI engine may modify a processing queue based on system needs and based on the reference data path parameters.

The AI engine may make decisions in real-time based on the reference data path parameters. For example, the data path parameters may include JVM name parameters. The AI engine may evaluate system resources and determine that JVM1, specified in the data path parameters, is in use. The AI engine may evaluate the basis for the specification. The AI engine may determine that JVM2 would be acceptable even though it is not specified. Based on a real-time snapshot of the system, the AI engine may proactively redirect the data packet to JVM2.

If the output data packet does not correspond to the reference data path parameters, the AI engine may lock down the data packet and prevent exit to downstream systems. The AI engine may function as an early warning system and may provide notification to upstream and/or downstream systems. The AI engine may issue an alert to a user interface associated with the system.

In some embodiments, the smart contract may automatically lock down the data packet upon a failure of the validation rules outlined in the contract. In some embodiments, the smart contract may automatically issue notifications to all parties defined in the contract.

The data packet may be validated against the reference data path parameters at multiple points within the system between input and output. The data path parameters may be validated between layers of an application. The data path parameters may be validated before and after processing by different intra-system applications. The output data packet may be validated at the point of exit from the system.

The number of times that the data path parameters are validated within the system and/or the triggers for each validation may depend on the type of file, the smart contract logic, the telemetry or TCP parameters, and/or any suitable factor. The number of times that the data path parameters are validated within the system and/or the triggers for each validation may be varied by the AI engine. The number of times that the data path parameters are validated within the system and/or the triggers for each validation may be varied by a system administrator.

One or more non-transitory computer-readable media storing computer-executable instructions are provided. When executed by a processor on a computer system, the instructions may perform a method for intelligent intra-system AI-based data authentication protocols.

The method may include receiving a data packet from an intersystem network. The method may include, at an AI engine, using a generative artificial intelligence algorithm, screening the network data and obtaining telemetry data and transfer control protocol (TCP) data associated with the data packet. The AI engine may output a set of data path parameters associated with the data packet.

The method may include, at the AI engine, validating an instance of a Java Virtual Machine (JVM) against the data path parameters. The AI engine may validate downstream application schema against the data path parameters. The AI engine may adapt the data path parameters based on smart contract rules. In some embodiments, the AI engine may dynamically adapt the data path parameters and/or the smart contract rules based on a real-time snapshot of system resources.

The method may include processing the JVM instance using one or more intra-system applications. The AI engine may authenticate the data packet against the data path parameters in a multi-stage intra-system authentication. A first authentication may be implemented at initiation of the JVM instance. A second authentication may be implemented at completion of processing at the JVM instance. A third authentication may be implemented at a point of exit from the system.

The number and timing of stages of authentication may be varied based on the smart contract rules. The number and timing of stages of authentication may be varied by the AI engine. The number and timing of stages of authentication may be varied by a system administrator.

The method may include, when the first, second, or third authentication fails to validate the data packet against the data path parameters, issuing an alert. The AI engine may notify upstream and downstream applications. The AI engine may restrict the data packet, preventing transmission past a point of restriction.

Apparatus and methods in accordance with this disclosure will now be described in connection with the figures, which form a part hereof. The figures show illustrative features of apparatus and method steps in accordance with the principles of this disclosure. It is to be understood that other embodiments may be utilized, and that structural, functional, and procedural modifications may be made without departing from the scope and spirit of the present disclosure.

The steps of methods may be performed in an order other than the order shown or described herein. Embodiments may omit steps shown or described in connection with illustrative methods. Embodiments may include steps that are neither shown nor described in connection with illustrative methods. Illustrative method steps may be combined. For example, an illustrative method may include steps shown in connection with another illustrative method.

Apparatus may omit features shown or described in connection with illustrative apparatus. Embodiments may include features that are neither shown nor described in connection with the illustrative apparatus. Features of illustrative apparatus may be combined. For example, an illustrative embodiment may include features shown in connection with another illustrative embodiment.

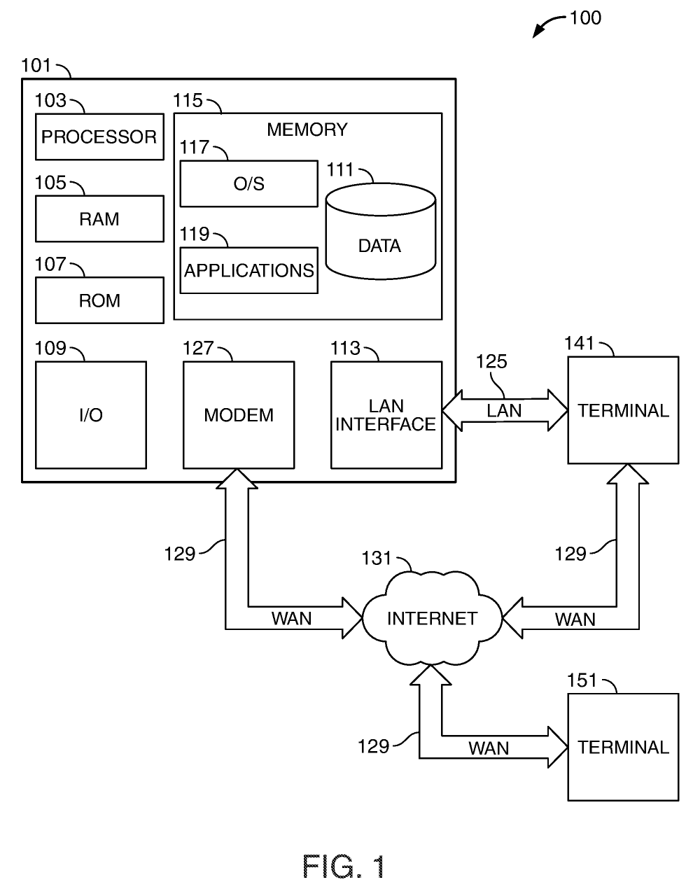

FIG. 1 shows an illustrative block diagram of system 100 that includes computer 101. Computer 101 may alternatively be referred to herein as an “engine,” “server,” or a “computing device.” Computer 101 may be a workstation, desktop, laptop, tablet, smartphone, or any other suitable computing device. Elements of system 100, including computer 101, may be used to implement various aspects of the systems and methods disclosed herein. Each of the systems, methods and algorithms illustrated below may include some or all of the elements and apparatus of system 100.

Computer 101 may include processor 103 for controlling the operation of the device and its associated components, and may include RAM 105, ROM 107, input/output (“I/O”) 109, and a non-transitory or non-volatile memory 115. Machine-readable memory may be configured to store information in machine-readable data structures. Processor 103 may also execute all software running on the computer. Other components commonly used for computers, such as EEPROM or flash memory or any other suitable components, may also be part of computer 101.

Memory 115 may include any suitable permanent storage technology, such as a hard drive. Memory 115 may store software including the operating system 117 and application program(s) 119 along with any data 111 needed for the operation of the system 100. Memory 115 may also store videos, text, and/or audio assistance files. The data stored in memory 115 may also be stored in cache memory, or any other suitable memory.

I/O module 109 may include connectivity to a microphone, keyboard, touch screen, mouse, and/or stylus through which input may be provided into computer 101. The input may include input relating to cursor movement. The input/output module may also include one or more speakers for providing audio output and a video display device for providing textual, audio, audiovisual, and/or graphical output. The input and output may be related to computer application functionality.

System 100 may be connected to other systems via a local area network (LAN) interface 113. System 100 may operate in a networked environment supporting connections to one or more remote computers, such as terminals 141 and 151. Terminals 141 and 151 may be personal computers or servers that include many or all of the elements described above relative to system 100. The network connections depicted in FIG. 1 include a local area network (LAN) 125 and a wide area network (WAN) 129 but may also include other networks. When used in a LAN networking environment, computer 101 may connect to LAN 125 through LAN interface 113 or an adapter. When used in a WAN networking environment, computer 101 may include modem 127 or other means for establishing communications over WAN 129, such as Internet 131.

It will be appreciated that the network connections shown are illustrative and other means of establishing a communications link between computers may be used. The existence of various well-known protocols such as TCP/IP, Ethernet, FTP, HTTP and the like is presumed, and the system can be operated in a client-server configuration to permit retrieval of data from a web-based server or application programming interface (API). Web-based, for the purposes of this application, is to be understood to include a cloud-based system. The web-based server may transmit data to any other suitable computer system. The web-based server may also send computer-readable instructions, together with the data, to any suitable computer system. The computer-readable instructions may include instructions to store the data in cache memory, the hard drive, secondary memory, or any other suitable memory.

Additionally, application program(s) 119, which may be used by computer 101, may include computer executable instructions for invoking functionality related to communication, such as e-mail, Short Message Service (SMS), and voice input and speech recognition applications. Application program(s) 119 (which may be alternatively referred to herein as “plugins,” “applications,” or “apps”) may include computer executable instructions for invoking functionality related to performing various tasks. Application program(s) 119 may utilize one or more algorithms that process received executable instructions, perform power management routines or other suitable tasks.

The invention may be described in the context of computer-executable instructions, such as application(s) 119, being executed by a computer. Generally, programs include routines, programs, objects, components, data structures, etc., that perform particular tasks or implement particular data types. The invention may also be practiced in distributed computing environments where tasks are performed by remote processing devices that are linked through a communications network. In a distributed computing environment, programs may be located in both local and remote computer storage media including memory storage devices. It should be noted that such programs may be considered, for the purposes of this application, as engines with respect to the performance of the particular tasks to which the programs are assigned.

Computer 101 and/or terminals 141 and 151 may also include various other components, such as a battery, speaker, and/or antennas (not shown). Components of computer system 101 may be linked by a system bus, wirelessly or by other suitable interconnections. Components of computer system 101 may be present on one or more circuit boards. In some embodiments, the components may be integrated into a single chip. The chip may be silicon-based.

Terminal 141 and/or terminal 151 may be portable devices such as a laptop, cell phone, tablet, smartphone, or any other computing system for receiving, storing, transmitting and/or displaying relevant information. Terminal 141 and/or terminal 151 may be one or more user devices. Terminals 141 and 151 may be identical to system 100 or different. The differences may be related to hardware components and/or software components.

The invention may be operational with numerous other general purpose or special purpose computing system environments or configurations. Examples of well-known computing systems, environments, and/or configurations that may be suitable for use with the invention include, but are not limited to, personal computers, server computers, hand-held or laptop devices, tablets, mobile phones, smart phones and/or other personal digital assistants (“PDAs”), multiprocessor systems, microprocessor-based systems, cloud-based systems, programmable consumer electronics, network PCs, minicomputers, mainframe computers, distributed computing environments that include any of the above systems or devices, and the like.

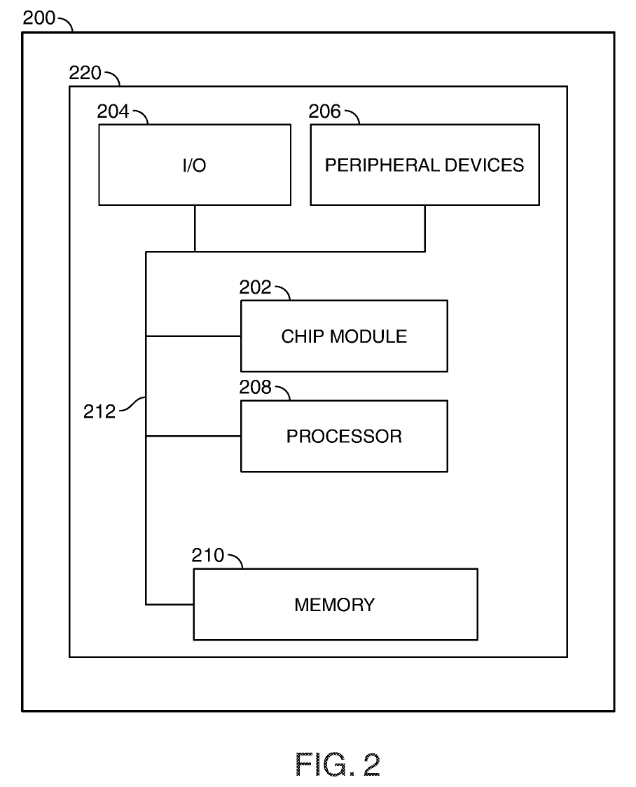

FIG. 2 shows illustrative apparatus 200 that may be configured in accordance with the principles of the disclosure. Apparatus 200 may be a computing device. Apparatus 200 may include one or more features of the apparatus shown in FIG. 2. Apparatus 200 may include chip module 202, which may include one or more integrated circuits, and which may include logic configured to perform any suitable logical operations.

Apparatus 200 may include one or more of the following components: I/O circuitry 204, which may include a transmitter device and a receiver device and may interface with fiber optic cable, coaxial cable, telephone lines, wireless devices, PHY layer hardware, a keypad/display control device or any other suitable media or devices; peripheral devices 206, which may include counter timers, real-time timers, power-on reset generators or any other suitable peripheral devices; logical processing device 208, which may compute data structural information and structural parameters of the data; and machine-readable memory 210.

Machine-readable memory 210 may be configured to store in machine-readable data structures: machine executable instructions, (which may be alternatively referred to herein as “computer instructions” or “computer code”), applications such as applications 219, signals, and/or any other suitable information or data structures.

Components 202, 204, 206, 208, and 210 may be coupled together by a system bus or other interconnections 212 and may be present on one or more circuit boards such as circuit board 220. In some embodiments, the components may be integrated into a single chip. The chip may be silicon-based.

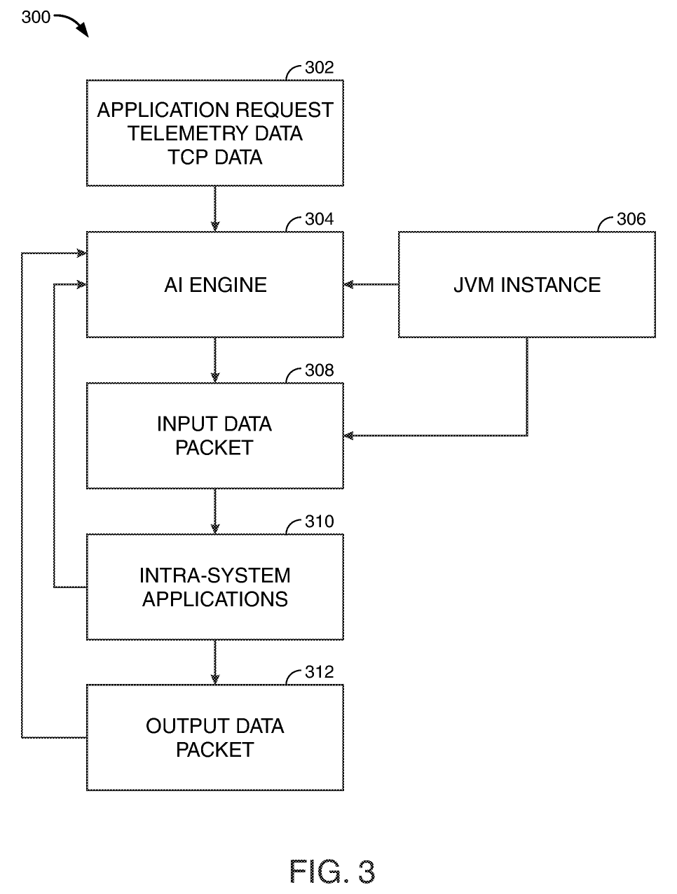

FIG. 3 shows illustrative process flow 300 for intelligent, adaptive intra-system authentication protocols. At 302, an application request may be executed by a network. The request may include one or more data packets. The network may generate telemetry and TCP data associated with the data packet.

AI engine 304 may interface with the network. AI engine 304 may include one or more generative AI algorithms. AI engine 304 may receive input data packet 308. AI engine 304 may obtain telemetry data and TCP data associated with the data packet. AI engine 304 may determine path parameters for the data packet. AI engine 304 may use these parameters to manage intra-system processing for the data packet. AI engine 304 may use parameters for multi-stage intra-system authentication.

AI engine 304 may access a smart contract (not shown). Smart contract rules may define protocols associated with the data path parameters.

AI engine 304 may verify JVM instance 306 against the data path parameters. AI engine 304 may ensure that JVM instance 306 will not modify the data packet in a manner that will cause it to deviate from the data path parameters. Alternatively, AI engine 304 may modify the data path parameters to accommodate changes that will be effected by JVM instance 306. AI engine 304 may modify the smart contract rules based on characteristics of JVM instance 306.

AI engine 304 may verify schema associated with intra-system applications 310 against the data path parameters. AI engine 304 may ensure that intra-system applications 310 will not modify the data packet in a manner that will cause it to deviate from the data path parameters. Alternatively, AI engine 304 may modify the data path parameters to accommodate changes that will be effected by intra-system applications 310. AI engine 304 may modify the smart contract rules based on characteristics of intra-system applications 310.

Intra-system applications 310 may process the input data packet. Malicious or corrupted data may be introduced at the database level, at the middleware level, and/or at outward facing system components. AI engine 304 may authenticate the data packet against data path parameters at multiple stages of intra-system processing. AI engine 304 may authenticate output data packet 312 against data path parameters. AI engine may authenticate the output data packet against data path parameters prior to its exit from the system.

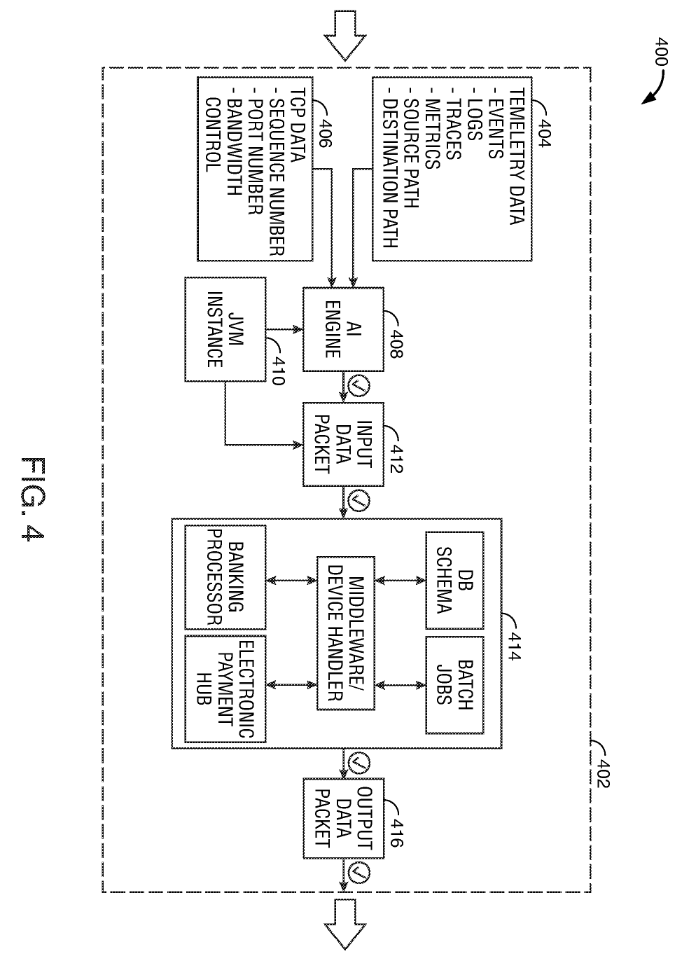

FIG. 4 shows illustrative process flow 400 for intelligent, adaptive intra-system authentication protocols. A data packet may be received at system 402 from an intersystem network (not shown). AI engine 408 may screen network data and obtain telemetry data 404 and TCP data 406 associated with the data packet. AI engine 408 may generate a set of reference data path parameters for the data packet based on the telemetry data. AI engine 408 may access a smart contract associated with the system (not shown). The smart contract may include rules for the set of reference data path parameters.

AI engine 408 may validate a JVM instance against the reference data path parameters. AI engine 408 may verify the data path parameters for input data packet 412 against the reference data path parameters. The smart contract may include rules for validating the data path parameters against the reference data path parameters. In some embodiments, the AI engine may dynamically modify the smart contract rules.

FIG. 4 shows validation of the data packet at entry to the system, before input to intra-system application 414, after processing by intra-system application 414, and at exit of output data packet 416 from system 402. The checkpoints shown are illustrative and other checkpoints may be used. Checkpoints may be specified in the smart contract rules. Checkpoints may be dynamically varied by AI engine 408 or by input from a system administrator. Checkpoints may be varied based on the content of a data packet, the type of intra-system processing, or based on any suitable factors.

Thus, methods and apparatus for INTELLIGENT INTRA-SYSTEM AUTHENTICATION PROTOCOLS are provided. Persons skilled in the art will appreciate that the present invention can be practiced by other than the described embodiments, which are presented for purposes of illustration rather than of limitation, and that the present invention is limited only by the claims that follow.

What is claimed is:

1. A method for adaptive intra-system authentication, the method comprising, at a generative artificial intelligence algorithm (AI algorithm):
receiving an intersystem data packet;
obtaining intersystem input data comprising network telemetry data and network transfer control protocol (TCP) data;
based on the input data, outputting a set of data path parameters associated with the data packet;
validating an instance of a Java Virtual Machine (JVM) against the data path parameters;
processing the data packet at the JVM instance;
authenticating the data packet in a multi-stage intra-system authentication comprising:
a first authentication of the data packet against the data path parameters at initiation of the JVM instance;
a second authentication of the data packet against the data path parameters at completion of processing at the JVM instance; and
a third authentication of the data packet against the data path parameters at transmission to a downstream application; and
when the first, second, or third authentication fails to validate the data packet against the data path parameters:
issuing an alert; and
restricting the data packet, the restricting preventing transmission of the data packet past a point of restriction.

2. The method of claim 1, further comprising, at the AI algorithm, determining the data path parameters for the data packet based on smart contract rules.

3. The method of claim 2, wherein a data packet header comprises an identifier for the smart contract.

4. The method of claim 2, further comprising, at the AI algorithm, modifying the smart contract rules based on a characteristic of the JVM instance.

5. The method of claim 2, further comprising validating a downstream application schema against the data path parameters.

6. The method of claim 5, further comprising, at the AI algorithm, modifying the smart contract rules based on a downstream application schema.

7. The method of claim 1, the network telemetry data comprising a metric, event, log, trace, data source path, data destination path, JVM instance name, and data center.

8. The method of claim 1, the network TCP data comprising a sequence number, bandwidth control parameter, and port number.

9. The method of claim 1, further comprising managing an intra-system load based on the data path parameters, the managing comprising routing the data packet for intra-system processing.

10. One or more non-transitory computer-readable media storing computer-executable instructions which, when executed by a processor on a computer system, perform a method for AI-based intra-system authentication protocols, the method comprising:
receiving an intersystem data packet;
obtaining intersystem input data comprising network telemetry data and network transfer control protocol (TCP) data; based on the input data, outputting a set of data path parameters associated with the data packet;
validating an instance of a Java Virtual Machine (JVM) against the data path parameters;
processing the data packet at the JVM instance;
authenticating the data packet in a multi-stage intra-system authentication comprising:
a first authentication of the data packet against the data path parameters at initiation of the JVM instance;
a second authentication of the data packet against the data path parameters at completion of processing at the JVM instance; and
a third authentication of the data packet against the data path parameters at transmission to a downstream application; and
when the first, second, or third authentication fails to validate the data packet against the data path parameters: issuing an alert; and
restricting the data packet, the restricting preventing transmission of the data packet past a point of restriction.

11. The media of claim 1, further comprising, at the AI algorithm, determining the data path parameters for the data packet based on smart contract rules.

12. The media of claim 2, further comprising, at the AI algorithm, modifying the smart contract rules based on a characteristic of the JVM instance.

13. The media of claim 1, the network telemetry data comprising a metric, event, log, trace, data source path, data destination path, JVM instance name, and data center.

14. The media of claim 1, the network TCP data comprising a sequence number, bandwidth control parameter, and port number.

15. A system for AI-based intra-system authentication protocols, the system comprising:
a processor;
a generative AI algorithm running on the processor, the AI algorithm generating data path parameters associated with a data packet based at least in part on network telemetry and TCP data from an intersystem network;
a JVM instance running on the processor, the JVM enabling processing of the data packet, the AI algorithm modifying a smart contract rule associated with the data path parameters based on the JVM instance;
an application running on the processor, the application processing the data packet, the AI algorithm modifying a smart contract rule associated with the data path parameters based on an application schema;
the AI algorithm configured to:
authenticate the data packet in a multi-stage intra-system authentication comprising:
a first authentication of the data packet against the data path parameters at initiation of the JVM instance;
a second authentication of the data packet against the data path parameters at completion of processing at the application; and
a third authentication of the data packet against the data path parameters at a point of exit from the system; and
when the first, second, or third authentication fails to validate the data packet against the data path parameters:
notify a downstream system; and
restrict the data packet, the restricting preventing transmission of the data packet past a point of restriction.

16. The system of claim 15, a header associated with the data packet comprising an identifier for the smart contract.

17. The system of claim 15, the network telemetry data comprising a metric, event, log, trace, data source path, data destination path, JVM instance name, and data center.

18. The system of claim 15, the network TCP data comprising a sequence number, bandwidth control parameter, and port number.

19. The system of claim 15, the AI algorithm further configured to route the data packet for intra-system processing based on the data path parameters.

20. The system of claim 15, the first authentication prior to batch processing and the second authentication following batch processing.
